(19) United States
(12) Patent Application Publication
(10) Pub. No.: US 2006/0067780 A1
(43) Pub. Date: Mar. 30, 2006

(54) Retail ski wax applicator

(76) Inventor: Danny K. Torman, Ogden, UT (US)

Correspondence Address: Danny K. Torman, 1079 Sharron Crt., Ogden, UT, 84404, US

(21) Appl. No.: 10/954,002

(22) Filed: Sep. 29, 2004

(51) Int. Cl. B43K 21/08

(52) U.S. Cl. 401/78; 401/75

(57) ABSTRACT

A retail ski wax applicator that includes a body or container, a protective cap, solid ski wax, worm gear, worm gear plate, and an adjustment knob. Individual can dial-out or in, the exact amount of solid ski wax that the person wants to rub-on or hot wax onto their skis or snowboards without handling the solid bar of ski wax. This way the skier or snowboarder can carry the applicator in their pocket without the ski wax coming in contact with their clothing and the applicator eliminates the possibility of bodily contact with a hot iron during the hot waxing process.

### BACKGROUND OF INVENTION

This invention relates to a portable retail ski wax applicator that is used by skiers and snowboarders that will add to the convenience and the ease of applying solid ski wax to their skis or snowboards

The retail ski wax applicator will allow a firm grip on the solid ski wax and in turn, will spread an even layer of wax onto the surface of the ski or snowboard.

### SUMMARY OF INVENTION

An important object of the invention is to provide an individual with a portable retail ski wax applicator that will allow the individual the freedom to carry the applicator in their pocket or backpack, that way they can apply the ski wax to their skis or snowboard whenever or wherever they need to.

### BRIEF DESCRIPTION OF THE DRAWINGS

The drawings illustrate, without thereto, a preferred embodiment of the invention, which accomplishes the foregoing and other objects, advantages, and functions. In the drawings, like parts are identified by like reference symbols in each of the views, and:

ILLUSTRATION. 1 is a 3D view of the applicator in accordance with the invention.

ILLUSTRATIONP. 2 is a side view of the applicator in accordance with the invention.

### DETAILED DESCRIPTION OF THE INVENTION

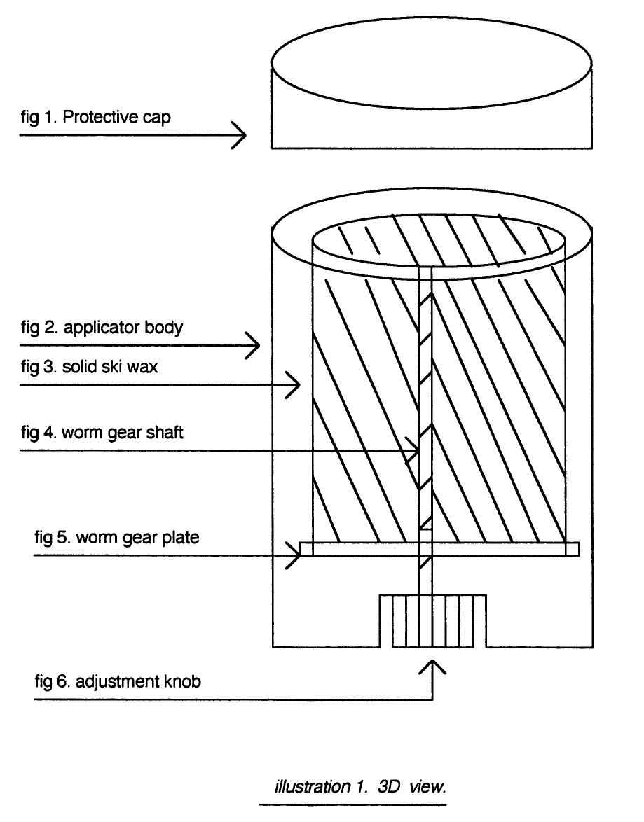

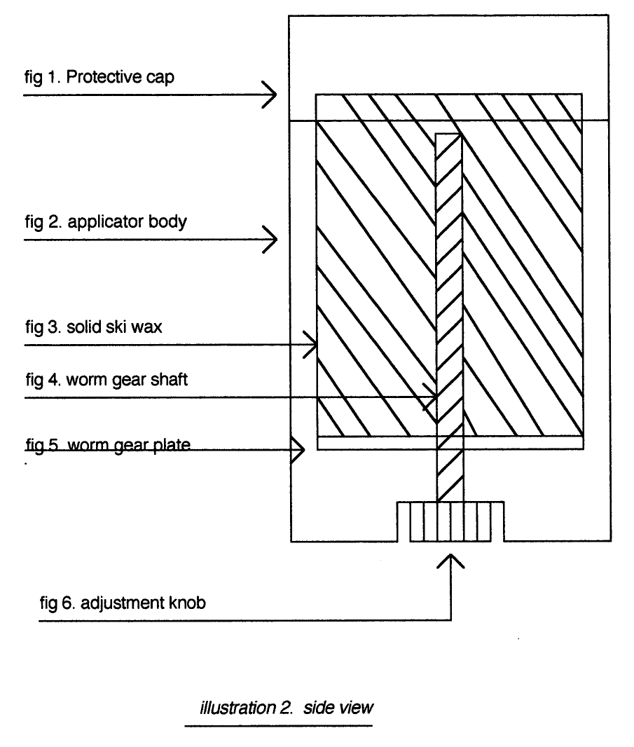

Referring to the illustrations, a retail ski wax applicator constitutes a preferred embodiment of the invention. The invention includes a FIG. 1 protective cap, FIG. 2 applicator body, FIG. 3 solid ski wax, FIG. 4 worm gear shaft, FIG. 5 worm gear plate, FIG. 6 adjustment knob.

Referring to illustrations 1 & 2

FIG. 1 A protective cap that snap's onto the applicator body by means of a small ridge on the applicator body, keeping contaminates away from the solid ski wax.

FIG. 2 A applicator body that house's and support's the solid ski wax allowing solid ski wax to travel up and down inside the container and protects the solid ski wax from contaminates. Applicator body is held in hand by individual, allowing complete control in the waxing process eliminating the possibility of burning individuals hands and applying a more uniform layer of ski wax onto the surface of the ski or snowboard.

FIG. 3 A solid ski wax made from a specific formula which is melted down to a certain temperature, then is allowed to cool down to a certain temperature and is poured directly into the body or applicator and then is allowed to cool down completely.

### DETAILED DESCRIPTION OF INVENTION (continued)

FIG. 4 A worm gear shaft that support's the solid ski wax and forces the ski wax to travel up and down inside the applicator and is permanently attached to the adjustment knob.

FIG. 5 A worm gear plate inside the applicator that is centered on the worm gear shaft that travels up or down on the shaft forcing the attached solid ski wax to go in or out of the applicator.

FIG. 6 A adjustment knob that turns the worm gear shaft that forces the worm gear plate and the attached solid ski wax to travel up or down inside of the applicator body.

While a detailed description of the invention has been described and illustrated, it will be apparent to those skilled in the art that various changes and modifications may be made therein within the sprit and scope of the invention. It is intended that such changes and modifications be included within the scope of the appended claims.

I claim:

1. A retail ski wax applicator which comprises: a body or container, a protective cap, solid ski wax, worm gear, worm gear plate, and an adjustment knob.

2. The applicator, will make the ski wax application process to skis or a snowboard completely portable, clean, and effortless.

3. The solid ski wax can be dialed out for the exact amount for rub-on or hot wax onto skis or snowboard and then dialed in, eliminating any waste, loss, to the remaining ski wax in the container.

4. Ski wax applicator will keep skier's or snowboarder's hands away from hot iron during the hot wax process.
